(19) United States
(12) Patent Application Publication
(10) Pub. No.: US 2019/0170126 A1
(43) Pub. Date: Jun. 6, 2019

(54) Energy-Saving Auxiliary Generating System

(71) Applicant: Joule Green Energy Co., Ltd., Taichung City (TW)

(72) Inventors: Chiu-Lin Huang, Shuishang Township (TW); Chao-Hu Li, Taichung City (TW)

(21) Appl. No.: 15/831,553

(22) Filed: Dec. 5, 2017

(51) Int. Cl. F03G 7/10; B65G 15/22; B65G 23/22

(52) U.S. Cl. CPC F03G 7/10; H02K 53/00; B65G 23/22; B65G 15/22

(57) ABSTRACT

An auxiliary generating system includes a plurality of weight members delivered repeatedly by a conveying device. The weight members are delivered upward by the conveying device to the upper end of a hollow conduit, then pass through the hollow conduit, then fall into multiple carrying grooves of a rotating wheel to rotate the rotating wheel and are then dropped onto the conveying device. When the rotating wheel is rotated, a gearbox and a generator are driven to operate. When the generator reaches a determined rotation speed, the generator produces an electric power.

### BACKGROUND OF THE INVENTION

### 1. Field of the Invention

The present invention relates to a generating system and, more particularly, to an auxiliary generating system.

### 2. Description of the Related Art

In recent years, the industrial technology brings convenience to the people, and also damages the ecological and environmental situations of the earth. Thus, more rules are built to restrict the industrial manufacturing process so as to satisfy the requirement of environmental protection. Especially, the requirement and development for electric power resources is a top priority. Many power generation procedures produce a large number of carbon emissions, that cause a high potential threat to the environment. Thus, it is necessary to provide a natural power generating method that does not cause pollution, so as to satisfy the requirement of environmental protection.

### BRIEF SUMMARY OF THE INVENTION

The primary objective of the present invention is to provide an energy-saving auxiliary generating system having an auxiliary generating function and having an energy-saving function.

In accordance with the present invention, there is provided an auxiliary generating system, comprising a working stand, a hollow conduit mounted on the working stand and arranged at a vertical state, a rotating wheel rotatably mounted on the working stand by a first mandrel and arranged under the hollow conduit, at least one conveying device having an inclined arrangement and having a first end located under the rotating wheel and a second end connected to an upper end of the hollow conduit, an auxiliary motor mounted on the working stand, a gearbox mounted on the working stand, a transmission mechanism mounted on the working stand, a generator mounted on the working stand, and a plurality of weight members delivered repeatedly by the at least one conveying device in a circulating manner. The gearbox includes a first spindle, a second spindle, a first rotation member mounted on the first spindle, and a second rotation member mounted on the second spindle. The auxiliary motor includes a second mandrel, and a third rotation member mounted on the second mandrel. The rotating wheel has a periphery provided with a plurality of carrying grooves. The first mandrel of the rotating wheel has a first end provided with a fourth rotation member and a second end provided with a fifth rotation member. An auxiliary transmission member is mounted between the third rotation member of the auxiliary motor and the fourth rotation member of the rotating wheel. The transmission mechanism includes a primary rotation member and a secondary rotation member which are coaxial and rotatable synchronously in concert with each other. A first transmission member is mounted between the first rotation member of the gearbox and the fifth rotation member of the rotating wheel. A second transmission member is mounted between the second rotation member of the gearbox and the primary rotation member of the transmission mechanism. The generator includes a third mandrel, and a sixth rotation member mounted on the third mandrel. A third transmission member is mounted between the sixth rotation member of the generator and the secondary rotation member of the transmission mechanism. The weight members are delivered upward by the at least one conveying device, pass through the hollow conduit, fall into the carrying grooves of the rotating wheel, are carried by rotation of the rotating wheel, and are dropped onto the at least one conveying device.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of an auxiliary generating system in accordance with the preferred embodiment of the present invention.

FIG. 2 is a locally enlarged view of the auxiliary generating system as shown in FIG. 1.

FIG. 3 is a partially perspective view of the auxiliary generating system in accordance with the preferred embodiment of the present invention.

FIG. 4 is a locally enlarged view of the auxiliary generating system as shown in FIG. 2.

FIG. 5 is a locally enlarged view of the auxiliary generating system as shown in FIG. 3.

FIG. 6 is a locally enlarged view of the auxiliary generating system as shown in FIG. 1.

### DETAILED DESCRIPTION OF THE INVENTION

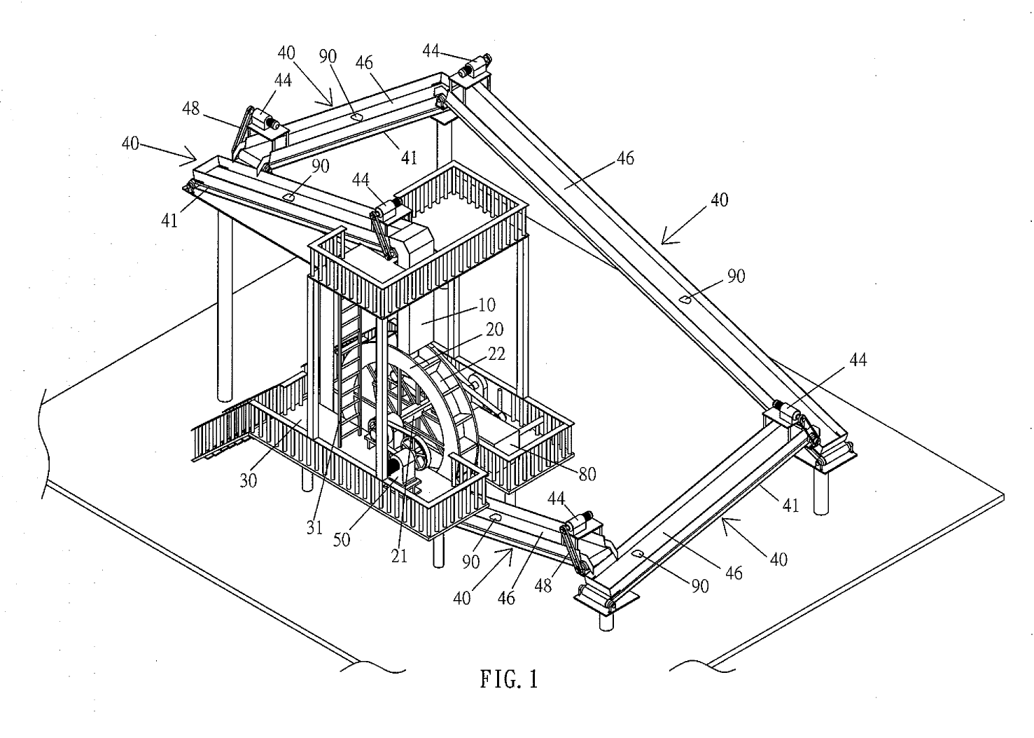

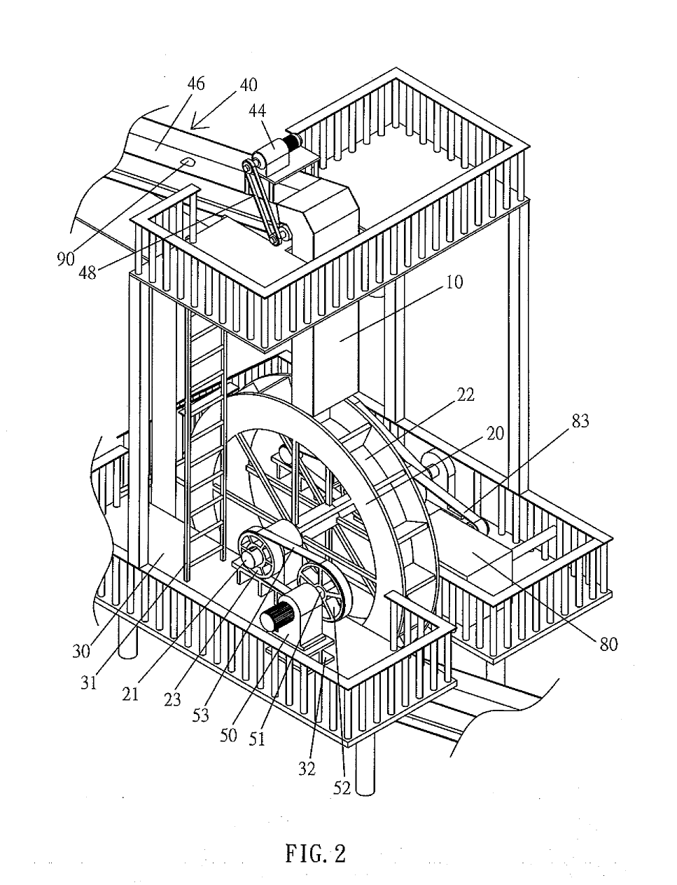

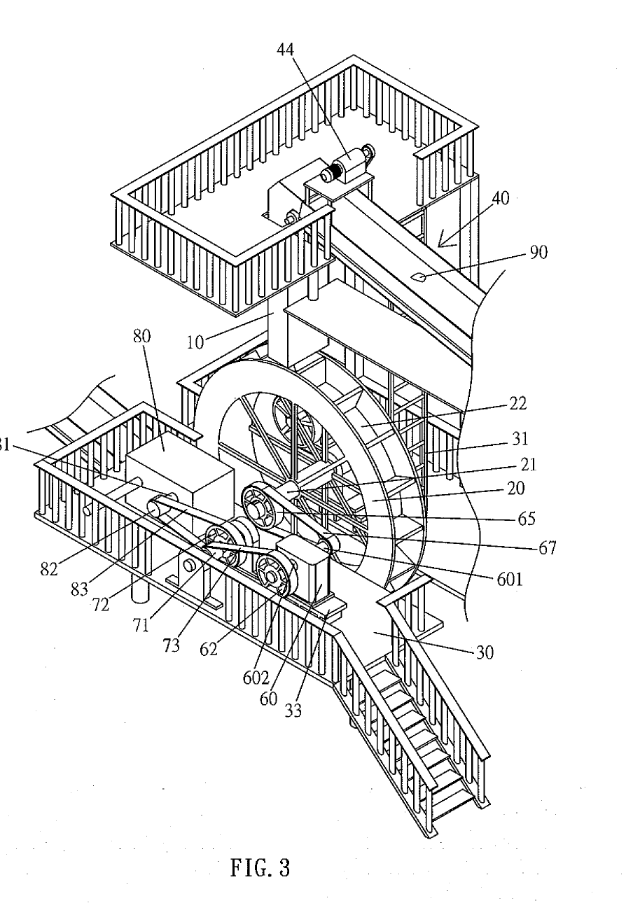

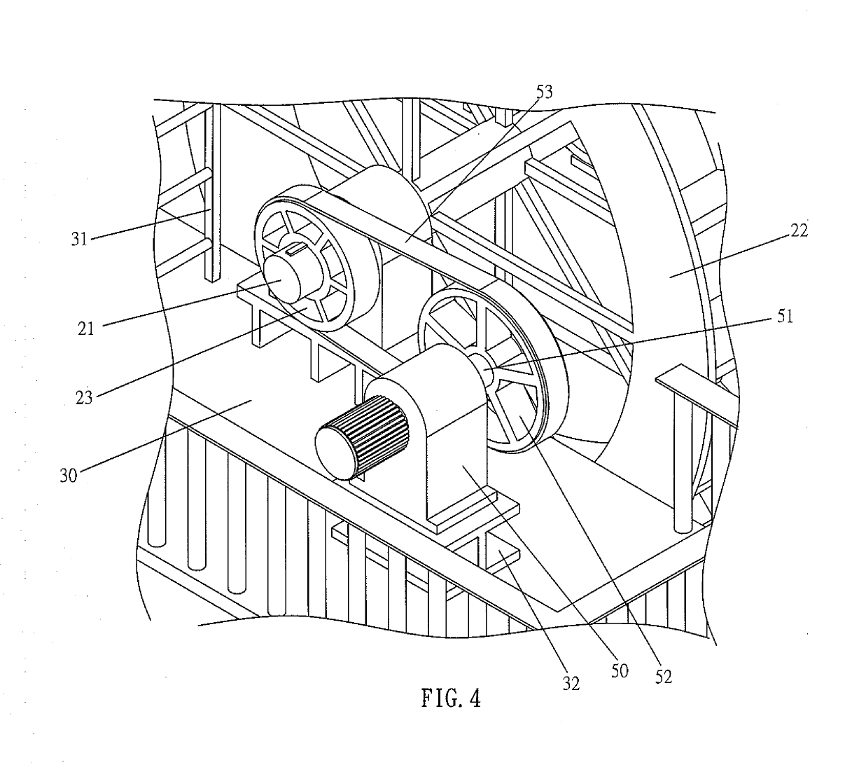

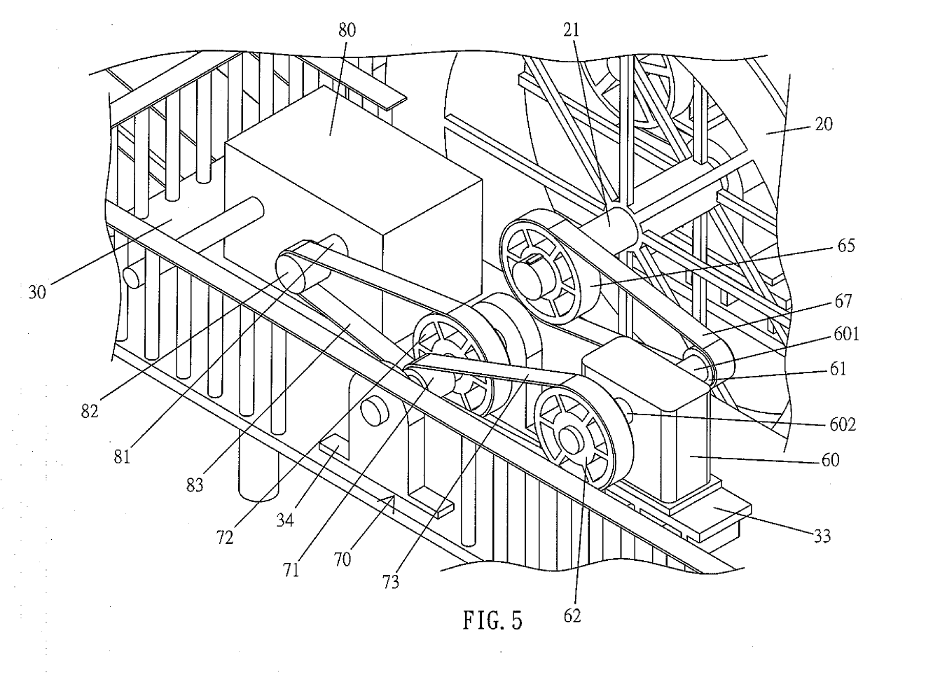

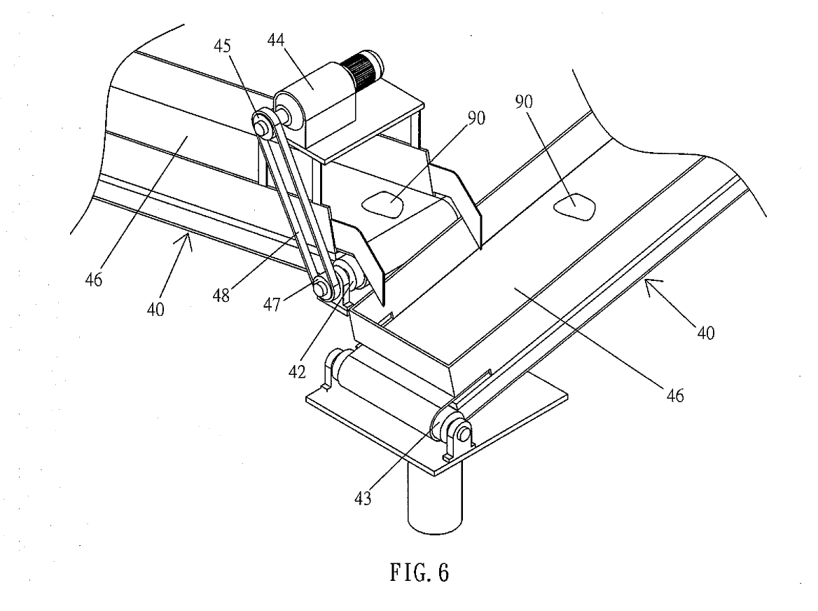

Referring to FIGS. 1-6, an auxiliary generating system in accordance with the preferred embodiment of the present invention comprises a working stand 30, a hollow conduit 10 mounted on the working stand 30 and arranged at a vertical state, a rotating wheel 20 rotatably mounted on the working stand 30 by a first mandrel 21 and arranged under the hollow conduit 10, at least one conveying device 40 having an inclined arrangement and having a first end located under the rotating wheel 20 and a second end connected to an upper end of the hollow conduit 10, an auxiliary motor 50 mounted on the working stand 30, a gearbox 60 mounted on the working stand 30, a transmission mechanism 70 mounted on the working stand 30, a generator 80 mounted on the working stand 30, and a plurality of weight members 90 delivered repeatedly by the at least one conveying device 40 in a circulating manner.

The gearbox 60 includes a first spindle 601, a second spindle 602, a first rotation member 61 mounted on the first spindle 601, and a second rotation member 62 mounted on the second spindle 602. The auxiliary motor 50 includes a second mandrel 51, and a third rotation member 52 mounted on the second mandrel 51. The rotating wheel 20 has a periphery provided with a plurality of carrying grooves 22. The first mandrel 21 of the rotating wheel 20 has a first end provided with a fourth rotation member 23 and a second end provided with a fifth rotation member 65. An auxiliary transmission member 53 is mounted between the third rotation member 52 of the auxiliary motor 50 and the fourth rotation member 23 of the rotating wheel 20. The transmission mechanism 70 includes a primary rotation member 71 and a secondary rotation member 72 which are coaxial and rotatable synchronously in concert with each other. A first transmission member 67 is mounted between the first rotation member 61 of the gearbox 60 and the fifth rotation member 65 of the rotating wheel 20. A second transmission member 73 is mounted between the second rotation member 62 of the gearbox 60 and the primary rotation member 71 of the transmission mechanism 70. The generator 80 converts a kinetic energy into an electrical energy. The generator 80 includes a third mandrel 81, and a sixth rotation member 82 mounted on the third mandrel 81. A third transmission member 83 is mounted between the sixth rotation member 82 of the generator 80 and the secondary rotation member 72 of the transmission mechanism 70. The weight members 90 are delivered upward by the at least one conveying device 40, pass through the hollow conduit 10, fall into the carrying grooves 22 of the rotating wheel 20, are carried by rotation of the rotating wheel 20, and are dropped onto the at least one conveying device 40.

In the preferred embodiment of the present invention, the at least one conveying device 40 includes a base 41, a drive motor 44 mounted on the base 41 and provided with a seventh rotation member 45, a first roller 42 mounted on the base 41 and provided with an eighth rotation member 47, a second roller 43 mounted on the base 41, a conveying belt 46 mounted between the first roller 42 and the second roller 43, and a fourth transmission member 48 mounted between the seventh rotation member 45 of the drive motor 44 and the eighth rotation member 47 of the first roller 42. The drive motor 44 has a power supplied by an external electric power or the generator 80. The drive motor 44 drives the fourth transmission member 48 which drives and rotates the conveying belt 46.

In the preferred embodiment of the present invention, each of the seventh rotation member 45 of the drive motor 44 and the eighth rotation member 47 of the first roller 42 is a belt wheel, and the fourth transmission member 48 is a belt. Alternatively, each of the seventh rotation member 45 of the drive motor 44 and the eighth rotation member 47 of the first roller 42 is a toothed wheel, and the fourth transmission member 48 is a toothed belt.

In the preferred embodiment of the present invention, the auxiliary motor 50 has a power supplied by an external electric power or the generator 80.

In the preferred embodiment of the present invention, each of the first rotation member 61 of the gearbox 60 and the fifth rotation member 65 of the rotating wheel 20 is a belt wheel, and the first transmission member 67 is a belt. In addition, each of the second rotation member 62 of the gearbox 60 and the primary rotation member 71 of the transmission mechanism 70 is a belt wheel, and the second transmission member 73 is a belt. In addition, each of the sixth rotation member 82 of the generator 80 and the secondary rotation member 72 of the transmission mechanism 70 is a belt wheel, and the third transmission member 83 is a belt. In addition, each of the third rotation member 52 of the auxiliary motor 50 and the fourth rotation member 23 of the rotating wheel 20 is a belt wheel, and the auxiliary transmission member 53 is a belt.

Alternatively, each of the first rotation member 61 of the gearbox 60 and the fifth rotation member 65 of the rotating wheel 20 is a toothed wheel, and the first transmission member 67 is a toothed belt. In addition, each of the second rotation member 62 of the gearbox 60 and the primary rotation member 71 of the transmission mechanism 70 is a toothed wheel, and the second transmission member 73 is a toothed belt. In addition, each of the sixth rotation member 82 of the generator 80 and the secondary rotation member 72 of the transmission mechanism 70 is a toothed wheel, and the third transmission member 83 is a toothed belt. In addition, each of the third rotation member 52 of the auxiliary motor 50 and the fourth rotation member 23 of the rotating wheel 20 is a toothed wheel, and the auxiliary transmission member 53 is a toothed belt.

In the preferred embodiment of the present invention, the auxiliary generating system further comprises a ladder 31 mounted on the working stand 30, a first fixed seat 32 mounted on the working stand 30 for mounting the auxiliary motor 50, a second fixed seat 33 mounted on the working stand 30 for mounting the gearbox 60, and a third fixed seat 34 mounted on the working stand 30 for mounting the transmission mechanism 70.

In the preferred embodiment of the present invention, each of the weight members 90 is a stone or lump.

In the preferred embodiment of the present invention, the auxiliary generating system comprises a plurality of conveying devices 40 which are connected serially and present an inclined upward arrangement.

In operation, after the auxiliary motor 50 and the drive motor 44 of the at least one conveying device 40 are started by the external electric power, the rotating wheel 20 and the conveying belt 46 of the at least one conveying device 40 are rotated.

When the conveying belt 46 of the at least one conveying device 40 is rotated, the weight members 90 are carried repeatedly by the conveying belt 46 of the at least one conveying device 40 in a circulating manner. Thus, the weight members 90 are delivered upward by the at least one conveying device 40, pass through the hollow conduit 10, fall into the carrying grooves 22 of the rotating wheel 20, are carried by rotation of the rotating wheel 20, and are dropped onto the at least one conveying device 40. At this time, the rotating wheel 20 is also rotated by the gravity of the weight members 90.

When the rotating wheel 20 is rotated, the fifth rotation member 65 is rotated to drive the first transmission member 67 which rotates the first rotation member 61 which drives and rotates the gearbox 60 which rotates the second rotation member 62 which drives the second transmission member 73 which rotates the primary rotation member 71 which rotates the secondary rotation member 72 which drives the third transmission member 83 which rotates the sixth rotation member 82 which drives the generator 80, so that the generator 80 is rotated to generate electricity.

It is appreciated that, the generator 80 reaches a determined rotation speed and generates an electric power by the ratio of the rotation members and the transmission members between the rotating wheel 20, the gearbox 60, the transmission mechanism 70 and the generator 80. After the auxiliary generating system is operated successively during a period of time, the electric power generated by the generator 80 is supplied to the auxiliary motor 50 and the drive motor 44 of the at least one conveying device 40.

Accordingly, the auxiliary motor 50 is operated to rotate the rotating wheel 20, to in turn drive and operate the gearbox 60, the transmission mechanism 70 and the generator 80. The generator 80 reaches a determined rotation speed and generates an electric power by the ratio of the rotation members and the transmission members between the rotating wheel 20, the gearbox 60, the transmission mechanism 70 and the generator 80. After the auxiliary generating system is operated successively during a period of time, the electric power generated by the generator 80 is integrated and stabilized to produce a steady electric power which is fed back to the auxiliary motor 50 and the drive motor 44 of the at least one conveying device 40. In addition, the residual electric power of the generator 80 is supplied to external appliances, to reduce consumption of the external electric power. Thus, the auxiliary generating system has an auxiliary generating function and has an energy-saving function.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. An auxiliary generating system, comprising:
a working stand;
a hollow conduit mounted on the working stand and arranged at a vertical state;
a rotating wheel rotatably mounted on the working stand by a first mandrel and arranged under the hollow conduit;
at least one conveying device having an inclined arrangement and having a first end located under the rotating wheel and a second end connected to an upper end of the hollow conduit;
an auxiliary motor mounted on the working stand;
a gearbox mounted on the working stand;
a transmission mechanism mounted on the working stand;
a generator mounted on the working stand; and
a plurality of weight members delivered repeatedly by the at least one conveying device in a circulating manner;
wherein:
the gearbox includes a first spindle, a second spindle, a first rotation member mounted on the first spindle, and a second rotation member mounted on the second spindle;
the auxiliary motor includes a second mandrel, and a third rotation member mounted on the second mandrel;
the rotating wheel has a periphery provided with a plurality of carrying grooves;
the first mandrel of the rotating wheel has a first end provided with a fourth rotation member and a second end provided with a fifth rotation member;
an auxiliary transmission member is mounted between the third rotation member of the auxiliary motor and the fourth rotation member of the rotating wheel;
the transmission mechanism includes a primary rotation member and a secondary rotation member which are coaxial and rotatable synchronously in concert with each other;
a first transmission member is mounted between the first rotation member of the gearbox and the fifth rotation member of the rotating wheel;
a second transmission member is mounted between the second rotation member of the gearbox and the primary rotation member of the transmission mechanism;
the generator includes a third mandrel, and a sixth rotation member mounted on the third mandrel;
a third transmission member is mounted between the sixth rotation member of the generator and the secondary rotation member of the transmission mechanism; and
the weight members are delivered upward by the at least one conveying device, pass through the hollow conduit, fall into the carrying grooves of the rotating wheel, are carried by rotation of the rotating wheel, and are dropped onto the at least one conveying device.

2. The auxiliary generating system of claim 1, wherein the auxiliary generating system comprises a plurality of conveying devices which are connected serially and present an inclined upward arrangement.

3. The auxiliary generating system of claim 1, wherein:
the at least one conveying device includes:
a base;
a drive motor mounted on the base and provided with a seventh rotation member;
a first roller mounted on the base and provided with an eighth rotation member;
a second roller mounted on the base;
a conveying belt mounted between the first roller and the second roller; and
a fourth transmission member mounted between the seventh rotation member of the drive motor and the eighth rotation member of the first roller;
the drive motor has a power supplied by an external electric power or the generator; and
the drive motor drives the fourth transmission member which drives and rotates the conveying belt.

4. The auxiliary generating system of claim 3, wherein each of the seventh rotation member of the drive motor and the eighth rotation member of the first roller is a belt wheel, and the fourth transmission member is a belt.

5. The auxiliary generating system of claim 3, wherein each of the seventh rotation member of the drive motor and the eighth rotation member of the first roller is a toothed wheel, and the fourth transmission member is a toothed belt.

6. The auxiliary generating system of claim 1, wherein the auxiliary motor has a power supplied by an external electric power or the generator.

7. The auxiliary generating system of claim 1, wherein:
each of the first rotation member of the gearbox and the fifth rotation member of the rotating wheel is a belt wheel, and the first transmission member is a belt;
each of the second rotation member of the gearbox and the primary rotation member of the transmission mechanism is a belt wheel, and the second transmission member is a belt;
each of the sixth rotation member of the generator and the secondary rotation member of the transmission mechanism is a belt wheel, and the third transmission member is a belt; and
each of the third rotation member of the auxiliary motor and the fourth rotation member of the rotating wheel is a belt wheel, and the auxiliary transmission member is a belt.

8. The auxiliary generating system of claim 1, wherein:
each of the first rotation member of the gearbox and the fifth rotation member of the rotating wheel is a toothed wheel, and the first transmission member is a toothed belt;
each of the second rotation member of the gearbox and the primary rotation member of the transmission mechanism is a toothed wheel, and the second transmission member is a toothed belt;
each of the sixth rotation member of the generator and the secondary rotation member of the transmission mechanism is a toothed wheel, and the third transmission member is a toothed belt; and
each of the third rotation member of the auxiliary motor and the fourth rotation member of the rotating wheel is a toothed wheel, and the auxiliary transmission member is a toothed belt.

9. The auxiliary generating system of claim 1, further comprising:
a ladder mounted on the working stand;
a first fixed seat mounted on the working stand for mounting the auxiliary motor;
a second fixed seat mounted on the working stand for mounting the gearbox; and
a third fixed seat mounted on the working stand for mounting the transmission mechanism.

10. The auxiliary generating system of claim 1, wherein each of the weight members is a stone or lump.
